(19) United States
(12) Patent Application Publication
(10) Pub. No.: US 2015/0374564 A1
(43) Pub. Date: Dec. 31, 2015

(54) A WHEELED VEHICLE AND A METHOD OF OPERATION THEREOF

(71) Applicant: Robert Sutton, Neutral Bay (AU)

(72) Inventor: Robert Sutton, Neutral Bay (AU)

(21) Appl. No.: 14/768,047

(22) PCT Filed: Feb. 3, 2014
(86) PCT No.: PCT/AU2014/000071

§ 371 Date: Aug. 14, 2015

(30) Foreign Application Priority Data
Feb. 15, 2013 (AU) 2013900489

(51) Int. Cl. A61G 5/06; A61G 5/10

(52) U.S. Cl. CPC A61G 5/061; A61G 5/063; A61G 5/1067

(57) ABSTRACT

The present invention relates to a wheeled vehicle and a method of operation thereof. The invention is particularly suitable for use in relation to mobility aids for the disabled. The wheeled vehicle includes a frame, a first wheel assembly including first and second wheels having parallel and spaced apart axes of rotation, wherein the first and second wheels are adapted to pivot about a first pivot axis relative to the frame, and a second wheel assembly including a third wheel adapted to pivot about a second pivot axis relative to the frame. Some embodiments are adapted to provide a wheeled vehicle that is capable for ascending and/or descending a step. Some embodiments are adapted to facilitate pivoting of the first and second wheel assemblies using a single actuator.

### FIELD OF THE INVENTION

The present invention relates to a wheeled vehicle and a method of operation thereof. The invention is particularly suitable for use in relation to mobility aids for the disabled and will be described hereinafter with reference to this application. However, it is to be appreciated that the invention is not limited to this particular field of use.

### BACKGROUND

Existing mobility aids, such as wheelchairs and the like, suffer from several disadvantages resulting in such mobility aids being unable to provide a user with true mobility.

For example, existing mobility aids comprise design and configuration compromises by having to conform to strict ‘ANSI/RESNA/FDA/ISO’ standard guidelines (i.e. the mobility aid must fit under a table).

Yet further, existing mobility aids are ill suited for ascending and descending curbs, often requiring the use of ramps, elevators and the like. Yet further, existing mobility aids may be rendered inoperative should a wheel be punctured. Yet further, existing mobility aids are ill suited for differing surfaces such as sand, snow and the like.

The present invention seeks to provide a vehicle and a method of operation thereof, which will overcome or substantially ameliorate at least some of the deficiencies of existing mobility aids, or to at least provide an alternative.

It is to be understood that, if any prior art information is referred to herein, such reference does not constitute an admission that the information forms part of the common general knowledge in the art, in Australia or any other country.

### SUMMARY OF THE INVENTION

Accordingly, in a first aspect, the present invention provides a wheeled vehicle including:

a frame;
a first wheel assembly including first and second wheels having parallel and spaced apart axes of rotation, wherein the first and second wheels are adapted to pivot about a first pivot axis relative to the frame;
a second wheel assembly including a third wheel adapted to pivot about a second pivot axis relative to the frame.

The first wheel assembly can include a first sub-frame pivotally coupled to the frame at the first pivot axis, wherein the second wheel is rotatably coupled to the first sub-frame at a fixed distance from the first pivot axis.

The first sub-frame can include a first arm pivotally coupled to a second arm, the second arm being pivotally coupled to the frame at the first pivot axis, wherein the first wheel is rotatably coupled to the first arm and the second wheel is rotatably coupled to the second arm whereby the first wheel is adapted to pivot about the pivotal coupling of the first arm to the second arm.

The second wheel assembly can include a second sub-frame pivotally coupled to the frame at the second pivot axis, wherein the third wheel is rotatably coupled to the second sub-frame.

The second sub-frame can include an arm having a proximal end pivotally coupled to the frame at the second pivot axis and a distal end linked to the third wheel.

The second sub-frame can include a second arm having a proximal end pivotally coupled to the frame at a third pivot axis and a linkage member extending between the distal ends of the first and second arms of the second sub-frame, the third wheel is coupled to linkage member which is maintained substantially horizontal through at least part of a pivotal range of motion of the third wheel about the second axis.

The second sub-frame can include a transverse member pivotally coupled to the linkage member, wherein the third wheel includes at least one wheel rotatably coupled to a distal end of the transverse member outboard of the linkage member, wherein the transverse member is adapted to pivot in a frontal plane relative to the linkage member.

The transverse member can include first and second vertically spaced apart transverse members, the first transverse member being pivotally coupled at a midpoint thereof to the linkage member, the second transverse member being pivotally coupled at a midpoint to the linkage member, wherein the pivotal coupling between the second transverse member and the linkage member is movable in an arcuate path, whereby distal outboard ends of the first and second linkage members are maintained in substantially fixed vertical and horizontal positions relative to each other through a pivotal range of motion of the first and second transverse members relative to the linkage member.

The pivotal coupling between the second transverse member and the linkage member can be biased towards a midpoint of the arcuate path in which the first and second transverse members are positioned transversely relative to the linkage member.

The third wheel can include a pair of swivel casters depending from distal ends of the transverse member outboard of the linkage member.

In some embodiments, the first wheel assembly is movable between three positions relative to the frame including first and second tilted positions and an intermediate position and the second wheel assembly is movable between two downwardly extending positions relative to the frame including a steep position and a shallow position, wherein in the first tilted position of the first wheel assembly the second wheel assembly is in the steep position, in the intermediate position of the first wheel assembly the second wheel assembly is in the shallow position and in the second tilted position the second wheel assembly is in the shallow position.

The vehicle can further include a mechanism for transmitting pivoting motion of the first wheel assembly about the first pivot axis or the second wheel assembly about the second pivot axis into pivoting motion of the other one of the first wheel assembly and the second wheel assembly.

The mechanism can be adapted to pivot the first wheel assembly or the second wheel assembly in response to an actuator pivoting the other one of the first wheel assembly and the second wheel assembly.

The frame can include a seat base support for supporting a seat base, wherein the first wheel assembly is pivotally coupled to the seat base support at the first pivot axis and the second wheel assembly is pivotally coupled to the seat base support at the second pivot axis.

The first pivot axis can be located towards a first end of the seat base support and the second pivot axis can be located towards an opposite second end of the seat base support.

In some embodiments, the vehicle includes a selectively engageable seat base lifting arm that has a proximal end pivotally coupled to the frame at the first pivot axis and when engaged is adapted to pivot with the first wheel assembly whereby a distal end of the seat base lifting arm is adapted to bear at least part of the weight of the seat base.

The seat base lifting arm can be engaged by being selectively pivotally locked to the first wheel assembly so as to tilt the seat base relative to the seat base support in response to the pivoting of the first wheel assembly.

The frame can include a seat back support pivotally coupled to the seat base support for pivoting the seat back support relative to the seat base support between a relatively upright position and a relatively reclined position.

In some embodiments, the seat back support is maintained in the upright position through a first part of a pivotal range of motion of the first wheel assembly about the first pivot axis and is movable relative to the reclined position through a second part of the pivotal range of motion of the first wheel assembly about the first pivot axis.

The first wheel assembly can be coupled to a cam for engaging a follower coupled to the seat back support, the cam including an arc shaped portion for contacting the follower through the first part of the pivotal range of motion of the first wheel assembly for maintaining the seat back support in the upright position, the cam also including a recessed portion for receiving the follower through the second part of the pivotal range of motion of the first wheel assembly for allowing movement of the seat back support relative to the reclined position.

In some embodiments, the vehicle includes a power storage device that is adapted to move fore and aft relative to the frame in response to pivoting of the first wheel assembly about the first pivot axis.

In another aspect, the present invention provides a method of operating a vehicle including a frame, a first wheel assembly including first and second wheels having parallel and spaced apart axes of rotation, wherein the first and second wheels are adapted to pivot about a first pivot axis relative to the frame, a second wheel assembly including a third wheel adapted to pivot about a second pivot axis relative to the frame, the method including:

configuring the vehicle in a first configuration in which the first wheel assembly is in a first tilted position and in which the second wheel assembly is in a steep position relative to the frame in which one of the first and second wheels is raised above a level surface and the other one of the first and second wheels and the third wheel are on the surface;
pivoting the first wheel assembly about the first pivot axis to an intermediate position relative to the frame and pivoting the second wheel assembly about the second pivot axis to a shallow position relative to the frame to configure the vehicle with the first, second and third wheels on the surface;
pivoting the first wheel assembly about the first pivot axis to a second tilted position relative to the frame to configure the vehicle in a configuration in which the first and second wheels are on the surface and the third wheel is raised above the surface.

In yet another aspect, the present invention provides a method for ascending a step using a vehicle including a frame, a first wheel assembly including first and second wheels having parallel and spaced apart axes of rotation, wherein the first and second wheels are adapted to pivot about a first pivot axis relative to the frame, a second wheel assembly including a third wheel adapted to pivot about a second pivot axis relative to the frame, the method including:

configuring the vehicle in a first configuration in which the first wheel assembly is in a first tilted position and in which the second wheel assembly is in a steep position relative to the frame in which one of the first and second wheels is raised above a level surface and the other one of the first and second wheels and the third wheel are on the surface;
pivoting the first wheel assembly about the first pivot axis to an intermediate position relative to the frame and pivoting the second wheel assembly about the second pivot axis to a shallow position relative to the frame to configure the vehicle with the first, second and third wheels on the surface;
pivoting the first wheel assembly about the first pivot axis to a second tilted position relative to the frame to configure the vehicle in a configuration in which the first and second wheels are on the surface and the third wheel is raised above the surface;
advancing the vehicle to place the third wheel on an upper surface of a step raised above the level surface;
pivoting the first wheel assembly to a position between the first titled position and the intermediate position and pivoting the second wheel assembly towards the steep position to lift one of the first and second wheels above the level surface and further advancing the vehicle to place the lifted one of the first and second wheels on the upper surface;
pivoting the first wheel assembly towards the intermediate position to lift the other one of the first and second wheels above the level surface and further advancing the vehicle to place the first, second and third wheels on the upper surface.

In still yet another aspect, the present invention provides a method for descending a step using a vehicle including a frame, a first wheel assembly including first and second wheels having parallel and spaced apart axes of rotation, wherein the first and second wheels are adapted to pivot about a first pivot axis relative to the frame, a second wheel assembly including a third wheel adapted to pivot about a second pivot axis relative to the frame, the method including:

configuring the vehicle in a first configuration in which the first wheel assembly is in a first tilted position and in which the second wheel assembly is in a steep position relative to the frame in which one of the first and second wheels is raised above a level surface and the other one of the first and second wheels and the third wheel are on the surface;
pivoting the first wheel assembly about the first pivot axis to an intermediate position relative to the frame and pivoting the second wheel assembly about the second pivot axis to a shallow position relative to the frame to configure the vehicle with the first, second and third wheels on the surface;
pivoting the first wheel assembly about the first pivot axis to a second tilted position relative to the frame to configure the vehicle in a configuration in which the first and second wheels are on the surface and the third wheel is raised above the surface;
advancing the vehicle to place the third wheel over an edge of a step and above the level of a lower surface and further advancing the vehicle to place one of the first and second wheels over the edge of the step causing the vehicle to tilt over the edge of the step until the one of the first and second wheel and the third wheel are on the lower surface;
further advancing the vehicle and pivoting the first wheel assembly to the intermediate position to configure the vehicle with the first, second and third wheels on the lower surface.

In still yet another aspect, the present invention provides a wheel assembly for a vehicle, the wheel assembly including at least two swivel castor wheels rotatably coupled to opposite ends of a transverse member, wherein at a point intermediate the opposite ends the transverse member is pivotally coupled to a linkage member that is adapted to be coupled to a vehicle, wherein the transverse member is adapted to pivot relative to the linkage member to provide for relative vertical movement of the swivel castor wheels and to maintain the swivel axes of the swivel castor wheels in a vertical orientation relative to the horizontal.

The transverse member can include first and second vertically spaced apart transverse members, the first transverse member being pivotally coupled at a midpoint thereof to the linkage member, the second transverse member being pivotally coupled at a midpoint to the linkage member, wherein the pivotal coupling between the second transverse member and the linkage member is movable in an arcuate path, whereby distal outboard ends of the first and second linkage members are maintained in substantially fixed vertically aligned positions relative to each other through a pivotal range of motion of the first and second transverse members relative to the linkage member.

The pivotal coupling between the second transverse member and the linkage member can be biased towards a midpoint of the arcuate path in which the first and second transverse members are positioned transversely relative to the linkage member.

The arcuate path can have a constant radius radiating from the pivotal coupling of the first transverse member to the linkage member.

### BRIEF DESCRIPTION OF THE DRAWINGS

Notwithstanding any other forms which may fall within the scope of the present invention, preferred embodiments of the invention will now be described, by way of example only, with reference to the accompanying drawings in which:

FIG. 1 shows an elevation view of a vehicle in accordance with an embodiment of the invention including a frame, a first wheel assembly pivotally coupled to the frame and a second wheel assembly pivotally coupled to the frame, wherein the first and second wheels assemblies and the frame are in a raised configuration;

FIG. 2 shows the vehicle of FIG. 1 in a lowered configuration;

FIG. 3 shows the vehicle of FIG. 1n a tilted configuration and a reclined configuration;

FIG. 4 shows the vehicle of FIG. 1 in a tilted configuration;

FIG. 5 shows the vehicle of FIG. 1 ascending a step

FIG. 6 shows the vehicle of FIG. 1 descending a step;

FIGS. 7a to 7f show the vehicle of FIG. 1 in a plurality of configurations in accordance with a method for ascending a step;

FIGS. 8a to 8f show the vehicle of FIG. 1 in a plurality of configurations in accordance with a method for descending a step;

FIG. 9 shows a perspective view of a frame of the vehicle in accordance with an embodiment of the invention;

FIGS. 10a to 10d show a portion of a second wheel assembly of the vehicle of FIG. 1 including a transverse member pivoting in a frontal plane;

FIGS. 11a to 11f show an elevation of the frame of the vehicle of FIG. 1 illustrating the operation of a seat base lifting arm and illustrating interaction of a cam of the first wheel assembly with the seat back support;

FIG. 12 shows another embodiment of the vehicle comprising tracks;

FIG. 13 shows another embodiment including multiple rotary actuators for pivoting the first and second wheel assemblies;

FIG. 14 shows a schematic representation of an embedded controller for the vehicle of FIG. 1;

FIG. 15 shows en embodiment of the vehicle including;

FIGS. 16 and 17 show the vehicle of FIG. 1 including a power storage device that is adapted to move fore and aft relative to the frame in response to pivoting of the first wheel assembly.

### DETAILED DESCRIPTION

It should be noted in the following description that like or the same reference numerals in different embodiments denote the same or similar features.

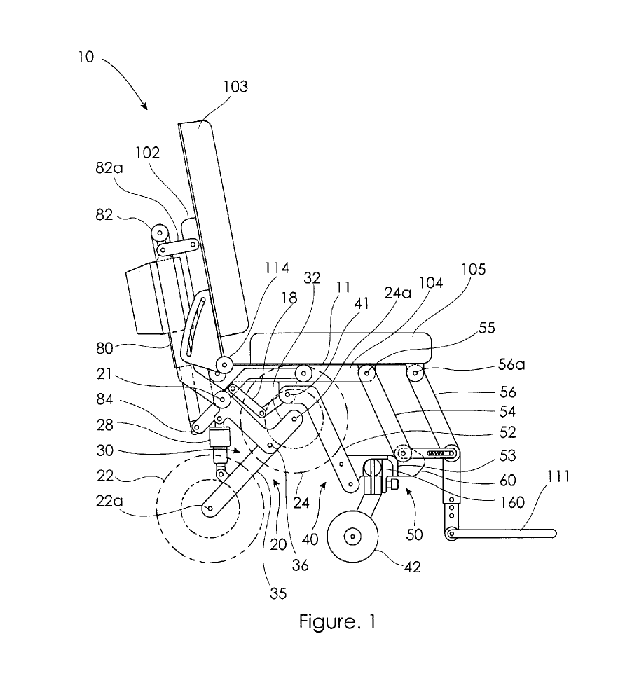

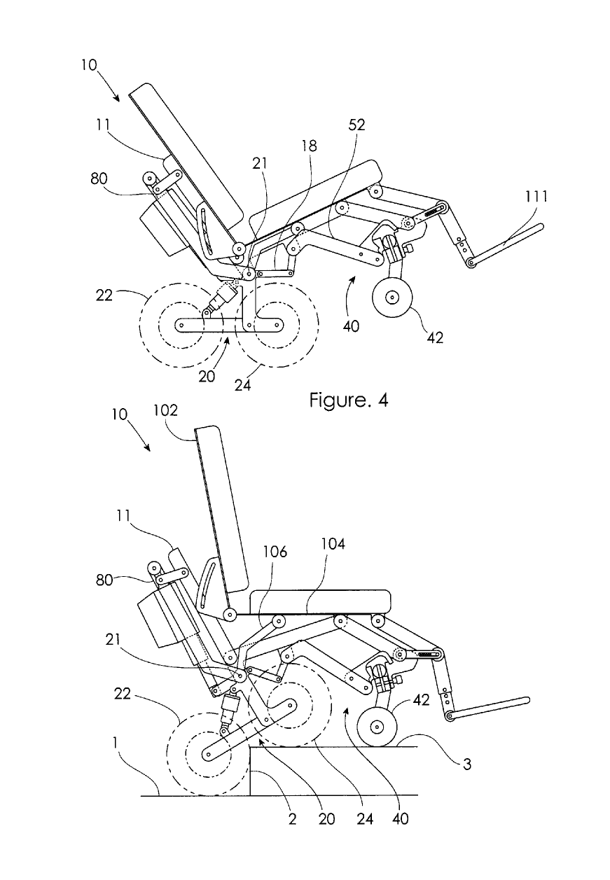

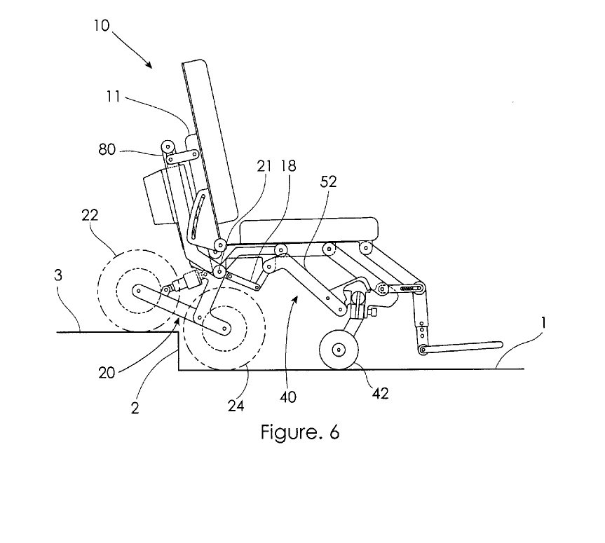

FIGS. 1 to 6 illustrate a wheeled vehicle 10 in accordance with an embodiment of the invention. With reference to the embodiment illustrated in FIG. 1, the invention relates to a wheeled vehicle 10 including a frame 11 including a first wheel assembly 20 including a first wheel 22 and a second wheel 24. The frame 11 includes a seat back support 102 and a seat base support 104 upon which a seat back 103 and seat base 105 are supported. The first wheel 22 and the second wheel 24 each have an axis of rotation 22a, 24a. The axes of rotation 22a, 24a of the first and second wheels 22, 24 are spaced apart and parallel from each other. The first and second wheels 22, 24 are adapted to pivot about a first pivot axis 21 relative to the frame 11. The vehicle 10 also includes a second wheel assembly 40 including a third wheel 42. The second wheel assembly 40 is configured such that the third wheel 42 is adapted to pivot about a second pivot axis 41 relative to the frame 11.

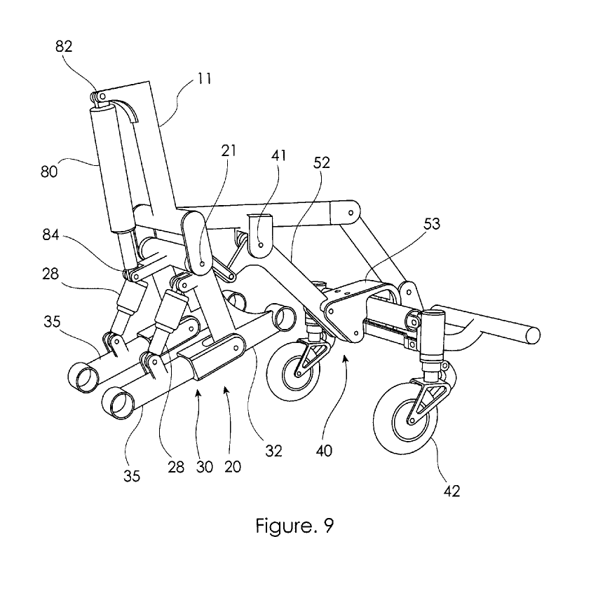

The first wheel assembly 20 includes a sub-frame 30 comprised of a pivoting arm 32 to which the second wheel 24 is rotatably coupled at the axis of rotation 24a. Thus, the second wheel 24 is coupled to the sub frame 30 at a fixed distance from the first pivot axis 21. As can be seen in the Figures, and in FIG. 9, the sub-frame 30 also includes a swing arm 35 pivotally coupled at a pivotal coupling 36 to the pivoting arm 32. The first wheel 22 is rotatably coupled to the swing arm 35 at the axis of rotation 22a. The first wheel 22 is adapted to pivot about the pivotal coupling 36 of the swing arm 35 to the pivoting arm 32. In the embodiment illustrated in FIG. 1, the first wheel assembly 20 includes a shock absorber device 28 for controlling relative pivotal movement of the swing arm 35 and the first wheel 22 relative to the pivoting arm 32 and the second wheel 24.

The second wheel assembly 40 includes a second sub-frame 50 pivotally coupled to the frame 11 at the second pivot axis 41. The third wheel 42 is rotatably coupled to the second sub-frame 50. The second sub-frame 50 includes an arm 52 having a proximal end pivotally coupled to the frame 11 at the second pivot axis 41 and a distal end connected indirectly to the third wheel 42. The second sub-frame 50 includes a second arm 54 having a proximal end pivotally coupled to the frame 11 at a third pivot axis 55 and a linkage member 60 extending between the distal ends of the first and second arms 52, 54 of the second sub-frame 50. Accordingly, the first and second arms 52, 54, the linkage member 60 and the frame 11 of the second wheel assembly 40 co-operate to form a generally quadrilateral arrangement. The second sub-frame is configured such that the linkage member 60 is maintained substantially level with the surface upon which the vehicle 10 is supported through at least part of a pivotal range of motion of the third wheel 42 about the second axis 41. Keeping the linkage member 60 level advantageously allows for castor wheels to be employed as the third wheel 42. However, it should be noted that in an alternative embodiment, the vehicle 10 may comprise a single support arm coupled to the linkage member 60. The vehicle 10 further includes a footrest 111 attached thereto. The footrest 111 is coupled to an end of an elongate member 56. An opposite end of the elongate member 56 is pivotally coupled to the seat base 105 at a pivotal coupling 56a. The elongate member 56 is pivotally coupled to the linkage 60 at a point intermediate the opposite ends of the elongate member 56. Accordingly, movement of the elongate member 56 and the footrest 111 coupled thereto is linked to movement of the linkage 60 of the second wheel assembly 40 between steep and shallow positions relative to the frame 11. Movement of the elongate member 56 and the footrest 111 coupled thereto between steep and shallow positions is also, to some extent, linked to movement of the seat base 105 relative to the seat base support 104 of the frame 11 as described herein. The footrest 111 is extendable relative to the elongate member 56 such as by telescopic means or the like so as to cater for differing user leg lengths.

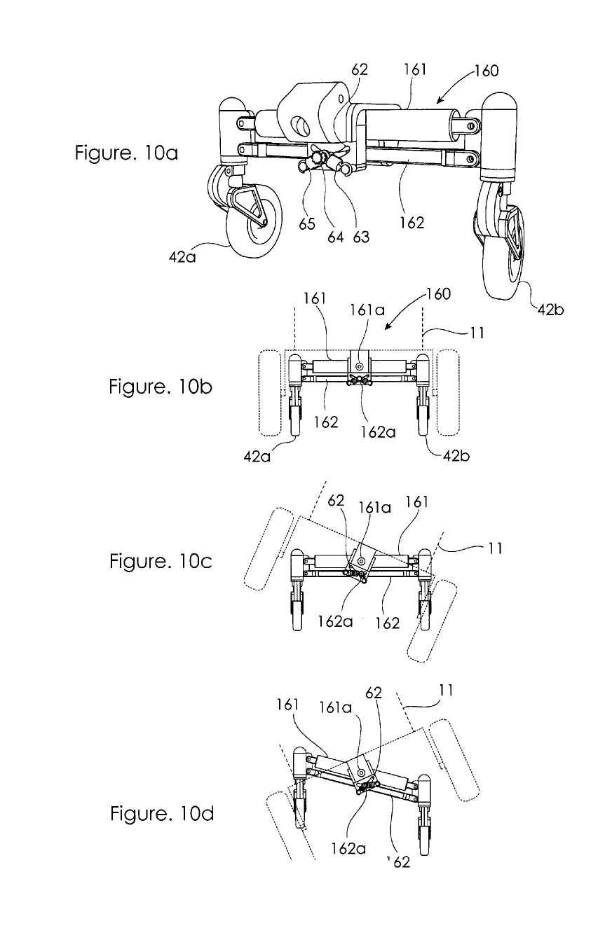

Referring to FIGS. 9 and 10a to 10d, it can be seen that the second sub-frame 50 of the second wheel assembly 40 comprises a transverse member 160 pivotally coupled to the linkage member 60. The third wheel 42 includes at least one and preferably two wheels 42a, 42b rotatably coupled to distal ends of the transverse member 160 outboard of the linkage member 60. The transverse member 160 is adapted to pivot in a frontal plane relative to frame 11, the first wheel assembly 20 and the linkage member 60. The transverse member 160 includes first and second vertically spaced apart transverse members 161, 162. The first transverse member 161 is pivotally coupled to the linkage member 60 via a pivotal coupling 161a located at a midpoint of the first transverse member 161. The second transverse member 162 is also pivotally coupled to the linkage member 60 via a pivotal coupling 162a located at a midpoint of the second transverse member 162. However, the pivotal coupling 162a between the second transverse member 162 and the linkage member 60 is movable in an arcuate path 62. The arcuate path 62 is configured radially to the pivotal coupling 161a of the first transverse member 161 to the linkage member 60. The radius of the arcuate path 62 is constant throughout and radiates from the pivotal coupling 161a of the first transverse member 161.

Distal outboard ends of the first and second transverse members 161, 162 are maintained in substantially fixed vertically aligned positions relative to each other through a pivotal range of motion, in the frontal plane, of the first and second transverse members 161, 162 relative to the linkage member 60. Keeping the outboard ends of the first and second transverse members 161, 162 maintained in substantially fixed vertically aligned positions relative to each other advantageously allows for the use of swivel castor wheels as the two transversely spaced apart wheels 42a, 42b of the third wheel 42. This is because for the swivel castor wheels 42a, 42b to work most effectively they should be maintained such that the swivel axis of the swivel castor wheels 42a, 42b (i.e. the axis about which the castor wheels 42a, 42b swivel) in a vertical orientation relative to the horizontal as otherwise the castor wheels 42a, 42b will tend to veer in directions depending on their orientation relative to the horizontal. Thus, the swivel axis of the pair of third wheels 42a, 42b, which are preferably swivel castor wheels, are maintained vertical despite relative vertical movement of the pair third wheels 42a, 42b such as might occur if one of the third wheels 42a, 42b were to roll over a hump or bump while the other one of the third wheels 42a, 42b remains on a level surface. The aforementioned arrangement provides for articulation of the third wheels 42a, 42b in the frontal plane relative to the frame 11 to ensure that both the third wheels 42a, 42b are in contact with the ground over uneven surfaces or where a surface upon which the third wheels 42a, 42b are placed is not level with a surface upon which the first and second wheels 22, 24 are placed as shown in FIGS. 10c and 10d. The arcuate path 62 allows the second transverse member 162 to pivot relative to the linkage member 60 and for the pivot coupling 162a, and associated pivot axis of the second transverse member 162, to move in an arcuate path relative to the linkage member 60 yet not in a linear path relative to the linkage member 60. Thus, the first and second transverse members 161, 162 are maintained in vertically aligned positions to thereby maintain the orientation of the third wheels 42a, 42b vertical regardless of whether the surface upon which the third wheels 42a, 42b are positioned is horizontal or not.

The pivotal coupling 162a between the second transverse member 162 and the linkage member 60 is biased towards a midpoint of the arcuate path 62. A pair of opposed spring members 63, 65 are coupled to the linkage member 60 and the second transverse member 162 and serve to bias the pivotal coupling 162a between the second transverse member 162 and the linkage member 60 towards the midpoint of the arcuate path 62. Biasing the pivotal coupling 162a between the second transverse member 162 and the linkage member 60 towards the midpoint of the arcuate path 62 serves to bias the first and second transverse members 161, 162 towards a transverse or horizontal position relative to the linkage member 60. The first and second transverse members 161, 162 and the wheels 42a, 42b coupled to outboard ends thereof are thereby able to pivot about the linkage member 60 in the frontal plane to advantageously allow both wheels 42a, 42b to remain in contact with the ground on uneven surfaces. Preferably, the wheels 42a, 42b are in the form of swivel casters depending from distal ends of the transverse member 160 outboard of the linkage member 60. The pivotal coupling of the first and second transverse members 161, 162 to the linkage 60 provide for pivotal movement of the transverse member 160 relative to the first and second arms 52, 54 of the second sub-frame 50 such that the ends at which the caster wheels 42a, 42b are connected are capable of moving up and down while the caster wheels 42a, 42b remain in a vertical orientation. Also provided is a frictional locking nut 64 to limit the pivotal movement of the transverse member 160.

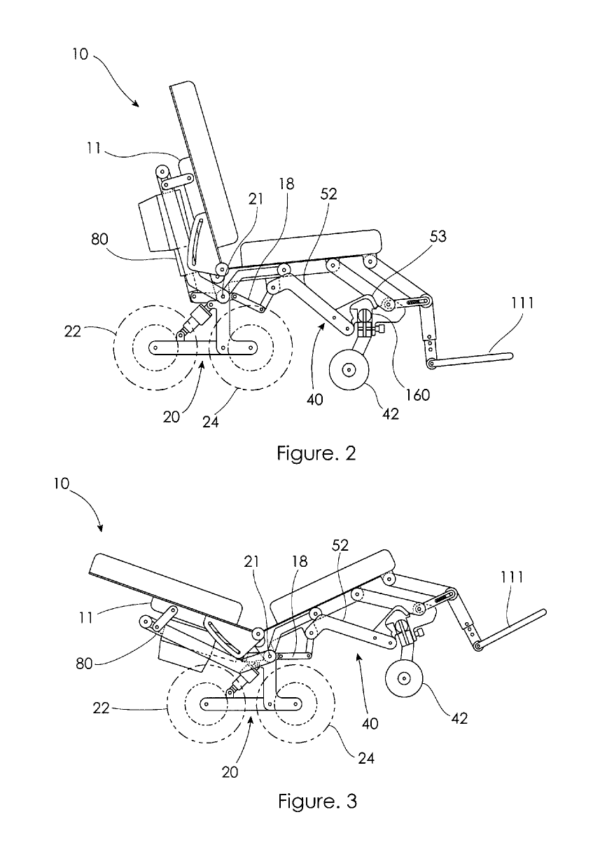

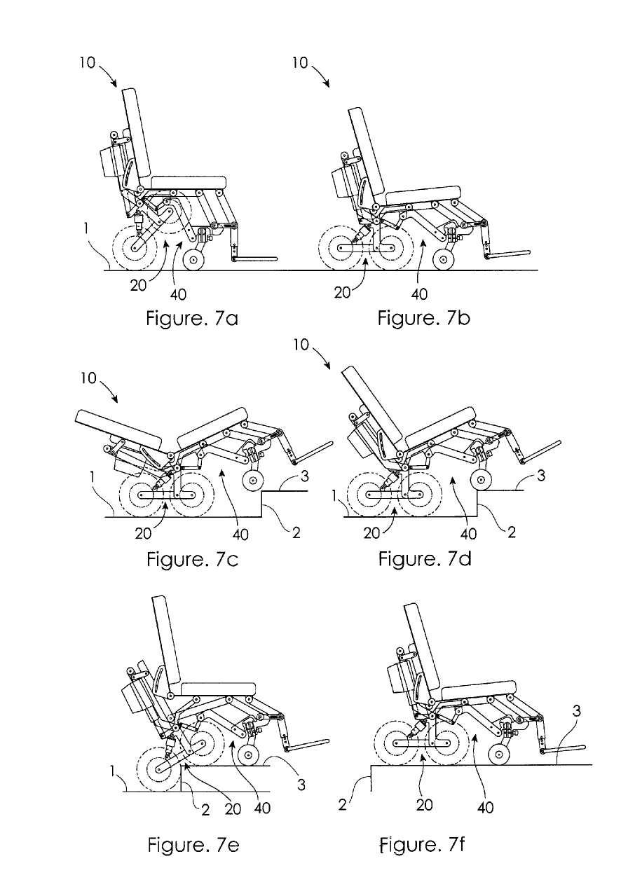

As can be seen in the Figures and in particular in FIGS. 9 and 10a to 10d, the first arm 52 includes an impingement mechanism 53. The impingement mechanism 53 is adapted to limit the pivotal movement of the transverse member 160. The impingement mechanism 53 is adapted to bear downwardly upon the transverse member 160 so as to limit the pivotal movement of the transverse member 160 in some configurations of the vehicle 10 and to allow pivotal movement of the transverse member 160 in other configurations of the vehicle 10. As is apparent from the different configurations of the vehicle 10 illustrated in the Figures, the impingement mechanism 53 is adapted to substantially prevent the pivotal movement of the transverse member 160 when the second wheel assembly 40 is in a steep position relative to the frame 11 such as when the vehicle 10 is in a raised configuration as illustrated in FIGS. 1, 7a and 8a as described below. Furthermore, the impingement mechanism 53 is adapted to allow pivotal movement of the transverse member 160 when the second wheel assembly 40 is in a shallow position relative to the frame 11 such as when the vehicle 10 is in a lowered configuration as illustrated in FIGS. 2, 7b and 8b as described below. The impingement mechanism 53 is also adapted to allow pivotal movement of the transverse member 160 when the second wheel assembly 40 is in a shallow position relative to the frame 11 such as when the third wheel 42 is raised above the surface such as in the configurations illustrated in FIGS. 3, 4, 7c, 7d, 8c and 8d as described below. The impingement mechanism 53 is also adapted to allow a reduced degree of pivotal movement of the transverse member 160 when the second wheel assembly 40 is in position between the shallow position and the steep position relative to the frame 11 such as in the configuration illustrated in FIGS. 5 and 7e as described below.

The vehicle 10 illustrated in FIGS. 1 to 6 includes an actuator 80 in the form of a linear mechanical actuator such as an electrical actuator or the like. The actuator 80 includes a first end 82 pivotally coupled to the frame 11 and a second end 84 pivotally coupled to the pivoting arm 32. Thus, the pivoting arm 32 has a substantially Z shaped profile when viewed from the side such as in FIGS. 1 to 6. The actuator 80 includes a telescopically expandable piston and cylinder arrangement. The first end 82 of the actuator 80 is pivotally coupled to the seat back support 102 of the frame 11 via a linkage assembly 82a to enable the actuator 80 to pivot the seat back support 102 relative to the seat base support 104. The linkage assembly 82a is adapted to enable the first end 82 of the actuator 80 to move in a limited range of motion relative to the seat back support 102 of the frame 11. The second end 84 of the actuator 80 is adapted to move towards or away from the first end 82 when the actuator is contracted and expanded to thereby cause the pivoting arm 32, and the first wheel assembly 20 as a whole, to pivot about the first pivot axis 21 relative to the frame 11.

The vehicle 10 includes a mechanism 18 that is adapted to cause the second wheel assembly 40 to pivot about the second pivot axis 41 in response to pivoting of the first wheel assembly 20 about the first pivot axis 21. In the embodiment illustrated in FIGS. 1 to 6, the mechanism 18 includes a mechanical linkage coupled to the first wheel assembly 20 adjacent to the first pivotal coupling 21 and to the second wheel assembly 40 adjacent to the second pivotal coupling 41. The mechanism 18 is operable to transmit pivoting motion of the first wheel assembly 20 about the first pivot axis 21 in one rotational direction into pivoting motion of the second wheel assembly 40 about the second pivot axis 41 in the opposite rotational direction. Accordingly, the vehicle 10 is adapted to cause pivotal movement of both the first and second wheel assemblies 20, 40 about their respective pivot axes 21, 41 through the use of a single actuator 80. As will become apparent from the description herein, the mechanism 18 advantageously allows the vehicle 10 to take on different configurations, such as the raised configuration shown in FIG. 1, the lowered configuration shown in FIG. 2 and other configurations illustrated in FIGS. 3 to 6 that are adapted for ascending and/or descending a step. The mechanism 18 is advantageous in that it removes the requirement for separate actuators to actuate the first and second wheel assemblies 20, 40 about the first and second pivotal couplings 21, 41. The mechanism may take a form other than the pivotally coupled arm illustrated in the Figures such as a belt drive or chain drive mechanism.

As will become apparent from the description below, the vehicle 100 provides several advantages including height adjustment, uneven terrain capabilities, variable wheelbase, improved stability and curb/step ascending and descending ability.

Throughout the specification, reference to first, second and third wheels should not be construed as being limited to three wheels only. Specifically, the reference to the first wheel 22 may be considered to be a reference to two or more adjacent, axially aligned and spaced apart wheels which may be differentially driven. Similarly, the reference to the second wheel 24 may be considered to be a reference to two or more adjacent, axially aligned and spaced apart wheels which may be differentially driven. In a preferred embodiment, the second wheel 24 comprises a pair of axially aligned and spaced apart wheels on opposite lateral sides of the vehicle 10. Each of the wheels comprising the second wheel 24 is differentially driven by an electrically powered drive motor (not shown) to provide for forward and reverse motion of the vehicle 10 as well as to steer the vehicle 10. The wheels comprising the first wheel 22 may also be differentially driven by an electrically powered or otherwise powered drive motor (not shown) to provide for forward and reverse motion of the vehicle 10 as well as to steer the vehicle 10. The motors for driving the first and second wheels 22, 24 may include a hub motor located within the hub of the first wheel 22 and/or the second wheel 24. As described above, the first wheel 22 and the second wheel 24 can each include two adjacent, axially aligned and spaced apart wheels. In an embodiment, a left one of the first wheel 22 and/or the second wheel 24 is driven by a first motor and a right one of the first wheel 22 and/or second wheel 24 is driven by a second motor. In this manner operation of the motors may be independently controlled to differentially drive the left and right wheels of the vehicle 10 to provide steering capabilities for the vehicle 10.

Similarly, the reference to the third wheel 42 may include a reference to two or more adjacent, axially aligned and spaced apart wheels. In this manner, reference to the first wheel 22, the second wheel 24 and the third wheel 42 could represent, in an embodiment, that the vehicle 10 comprises six wheels, comprised of three sets of axially aligned pairs of wheels. However, for the purposes of this specification, the terms first second and third are primarily used to distinguish wheels or sets of wheels from the front to the rear of the vehicle 10.

Furthermore, reference to first, second and third wheels should not be construed with a positional limitation in mind. For example, the second wheel assembly 40 need not necessarily be located towards a front or forward end of the vehicle 10 or forward of the first wheel assembly 20, but may instead be positioned towards a rear or rearward end of the vehicle 10 or rearward of the first wheel assembly 20.

As will be apparent from the description below, the first wheel assembly 20 advantageously provides for a mechanism for raising and lowering the first wheel 22 and the second wheel 24 with respect to each other. However, it should be noted that in other embodiments, the first wheel 22 and the second wheel 24 need not necessarily be mechanically coupled by way of the first wheel assembly 20 and may, for example comprise independent height adjustment mechanisms.

Accordingly, the vehicle 10 is capable of being configured in several different configurations illustrated in FIGS. 1 to 6, 7a to 7f and 9a to 8f. Specifically, referring to the configuration shown in FIG. 1, the vehicle 10 is in a raised configuration, in which the first wheel assembly 20 is in a first tilted position or a forward tilted position in which the second wheel assembly 40 is in a steep position relative to the frame 11 whereby the first wheel 22 and the third wheel 42 are supported on a level surface and the second wheel 24 is raised above the level surface. In such a configuration the frame 11, and the seat back support 102 and the seat base support 104 upon which the seat back 103 and the seat base 105 are supported are maintained at a relatively high position above the level surface, thus providing the vehicle 10 with a relatively high centre of mass and a relatively short wheelbase.

Referring to FIG. 2, there is shown the vehicle 10 in a lowered configuration. The vehicle 10 assumes the lowered configuration by pivoting the first wheel assembly 20 about the first pivot axis 21 to an intermediate position relative to the frame 10, in which the first and second wheels 22, 24 are supported on the level surface, and pivoting the second wheel assembly 40 about the second pivot axis 41 to a shallow position relative to the frame 10 (i.e. in a position in which the third wheel 42 is closer to the frame 10 and located further forward relative to the frame 10) to configure the vehicle 10 with the first, second and third wheels 22, 24, 42 on the surface. In the configuration illustrated in FIG. 2, the frame 11, and the seat back support 102 and the seat base support 104 upon which the seat back 103 and the seat base 105 are supported are maintained at a relatively low position above the level surface, thus providing the vehicle 10 with a relatively low centre of mass. The first, second and third wheels 22, 24, 42 are also positioned to provide a relatively long wheelbase.

Referring to FIG. 3, the vehicle 10 is configured whereby the first wheel assembly 20 is pivoted about the first pivot axis 21 to a second tilted position relative to the frame 11. In the second titled position the first wheel assembly 20 is titled to an aft position or an opposite side of the intermediate position to the first tilted position illustrated in FIG. 1. In the second titled position, the vehicle 10 is configured such that the first and second wheels 22, 24 are on the surface and the third wheel 42 is raised above the surface. Thus, the frame 11 is tilted rearwardly such that the vehicle 10 assumes a “rearing” position in which the second wheel assembly 40 and the third wheel 42 rear-up off the surface. In the configurations illustrated in FIGS. 2 and 3, the second wheel assembly 40 remains in the same shallow position about the second pivot axis 41 relative to the frame 10.

Accordingly, as can be appreciated, the mechanism 18 is operable to pivot the second wheel assembly 40 from the steep position of FIG. 1 to the shallow position of FIG. 2 when the first wheel assembly 20 is pivoted by the actuator 80 between the first tilted position of FIG. 1 to the intermediate position of FIG. 2. The mechanism 18 is also operable to maintain the position of the second wheel assembly 40 about the second pivot axis 41 in the shallow position relative to the frame 10 whilst the second wheel assembly 40 is pivoted by the actuator 80 from the intermediate position of FIG. 2 to the second tilted position of FIG. 3.

In order for the vehicle 10 to ascend a step, the vehicle 10 is operated to adopt a sequence of the abovementioned configurations as illustrated in FIGS. 1 to 5 and 7a to 7f. The vehicle is initially configured in the configuration of FIGS. 1 and 7a, in which the first wheel assembly 20 is in a first tilted position and in which the second wheel assembly 40 is in a steep position relative to the frame 11 whereby the first wheel 22 and the third wheel 42 are supported on a level surface and the second wheel 24 is raised above the level surface. The vehicle 10 is then reconfigured to the configuration of FIGS. 2 and 7b by pivoting the first wheel assembly 20 about the first pivot axis 21 to the intermediate position relative to the frame 10, in which the first and second wheels 22, 24 are supported on the level surface, and pivoting the second wheel assembly 40 about the second pivot axis 41 to the shallow position relative to the frame 10 such that the first, second and third wheels 22, 24, 42 rest on the level surface. The vehicle 10 is further reconfigured to the configurations of FIGS. 3 and 7c by pivoting the first wheel assembly 20 about the first pivot axis 21 to the second tilted position relative to the frame 11 such that the first and second wheels 22, 24 are on the surface and the third wheel 42 is raised above the surface. The vehicle 10 is then advanced to place the third wheel 42 on an upper surface 3 of a step 2 raised above the level surface 1 as illustrated in FIG. 7d. The vehicle 10 is then reconfigured to the position illustrated in FIG. 7e by pivoting the first wheel assembly 20 to a position between the first tilted position of FIGS. 1 and 7c and the intermediate position of FIGS. 2 and 7b and pivoting the second wheel assembly 40 towards the steep position to lift the second wheel 24 above the level surface 1. The vehicle 10 is then further advanced to place the lifted second wheel 24 on the upper surface 3 as illustrated in FIG. 7f.

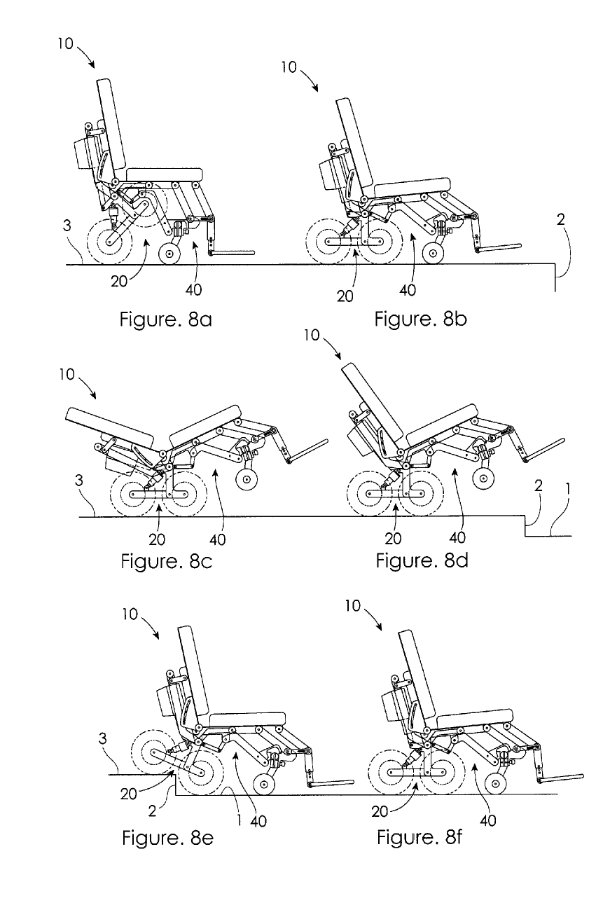

In order for the vehicle 10 to descend a step, the vehicle 10 is operated to adopt a sequence of configurations as illustrated in FIGS. 8a to 8f. The vehicle 10 is initially configured in the configuration of FIGS. 1 and 8a, in which the first wheel assembly 20 is in a first tilted position and in which the second wheel assembly 40 is in a steep position relative to the frame 11 whereby the first wheel 22 and the third wheel 42 are supported on a level surface 1 and the second wheel 24 is raised above the level surface 1. The vehicle 10 is then reconfigured to the configuration of FIGS. 2 and 8b by pivoting the first wheel assembly 20 about the first pivot axis 21 to the intermediate position relative to the frame 10, in which the first and second wheels 22, 24 are supported on the level surface 1, and pivoting the second wheel assembly 40 about the second pivot axis 41 to the shallow position relative to the frame 10 such that the first, second and third wheels 22, 24, 42 rest on the level surface 1. The vehicle 10 is further reconfigured to the configuration of FIGS. 3 and 8c by pivoting the first wheel assembly 20 about the first pivot axis 21 to the second tilted position relative to the frame 11 such that the first and second wheels 22, 24 are on the surface and the third wheel 42 is raised above the surface 1. The vehicle 10 is then advanced to place the third wheel 42 over an edge of a step 2 and above the level of a lower surface 4 and further advancing the vehicle 10 to place the second wheel 24 over the edge of the step 2 while pivoting the first wheel assembly 20 to a position between the intermediate position of FIGS. 2 and 8b and the second tilted position of FIGS. 3 and 8e until the second wheel 24 and the third wheel 42 are on the lower surface 4. The vehicle 10 is further advanced and the first wheel assembly 20 is pivoted to the intermediate position to configure the vehicle 10 with the first, second and third wheels 22, 24 and 42 on the lower surface 4.

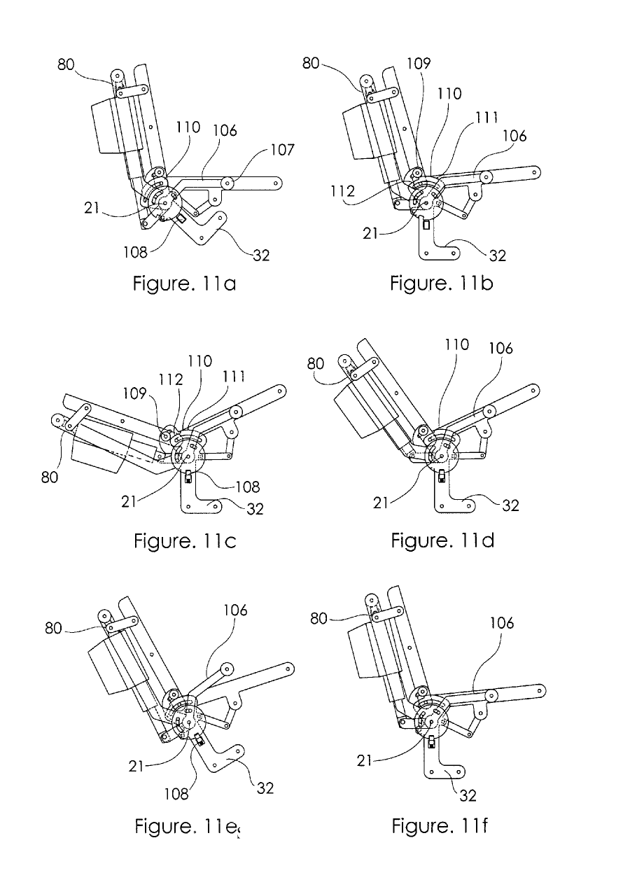

FIGS. 11a to 11f illustrate, in detail, a selectively engageable seat base lifting arm 106 that is operable for titling the seat base support 104 and preferably also the seat back support 102 relative to the frame 11 as well as partially lifting the seat base support 104 and the seat back support 102 relative to the frame 11. The seat base lifting arm 106 is pivotally coupled at a proximal end to the frame 11 at the first pivot axis 21. The seat base lifting arm 106 is engaged by being selectively pivotally locked to the first wheel assembly 20 by a selectively engageable locking mechanism 108. When engaged, the seat base lifting arm 106 is adapted to pivot with the first wheel assembly 20 about the first pivot axis 21 whereby a distal end 107 of the seat base lifting arm 106 is adapted to bear at least part of the weight of the seat base 105 by being elevated above the seat base support 104 as illustrated in FIGS. 5, 7e and 11e. The seat base lifting arm 106 is adapted to tilt the seat base 105 relative to the seat base support 104 in response to the pivoting of the first wheel assembly 20. The seat base 105 is preferably pivotally coupled at the third pivot axis 55 to facilitate tilting the seat base 105 relative to the seat base support 104 in response to the pivoting of the seat base lifting arm 106 with the first wheel assembly 20. By tilting the seat base 105 relative to the seat base support 104, the weight of the vehicle 10 with a user sitting on the seat base 104 may be shifted forward over the second wheel 24 and the upper level 3 when the vehicle is ascending the step 2 as illustrated in FIGS. 5 and 7e. Furthermore, as the seat base lifting arm 106 is pivotally locked to the first wheel assembly 20 the weight of a user bearing on the seat base 105 and the seat base lifting arm 106 can contribute to pivoting the first wheel assembly 20 when the second wheel 24 is placed on the upper surface 3 to thereby lift the first wheel 22 above the lower surface 1. Thus, the configuration of the seat base lifting arm 106 may enable a relatively less powerful actuator 108 to be adopted thereby reducing the overall weight of the vehicle 10.

The seat back support 102 is pivotally coupled at pivotal coupling 114 to the seat base support 104 for allowing the seat back support 102 to pivot relative to the seat base support 104 between a relatively upright position, illustrated in FIGS. 1, 7a, 8a and 11a, and a relatively reclined position illustrated in FIGS. 3, 7c, 8c and 11c. The seat back support 102 is maintained in the upright position through a first part of a pivotal range of motion of the first wheel assembly 20 about the first pivot axis 21 and is movable relative to the reclined position through a second part of the pivotal range of motion of the first wheel assembly 20 about the first pivot axis 21. The first wheel assembly 20 is coupled to a cam 110 for engaging a follower 109 coupled to the seat back support 102. The cam 110 includes an arc shaped portion 111 for contacting the follower 109 through the first part of the pivotal range of motion of the first wheel assembly 20 for maintaining the chair back support 102 in the upright position. The cam 110 also includes a recessed portion 112 for receiving the follower 109 through the second part of the pivotal range of motion of the first wheel assembly 20 for allowing movement of the chair back support 102 relative to the reclined position.

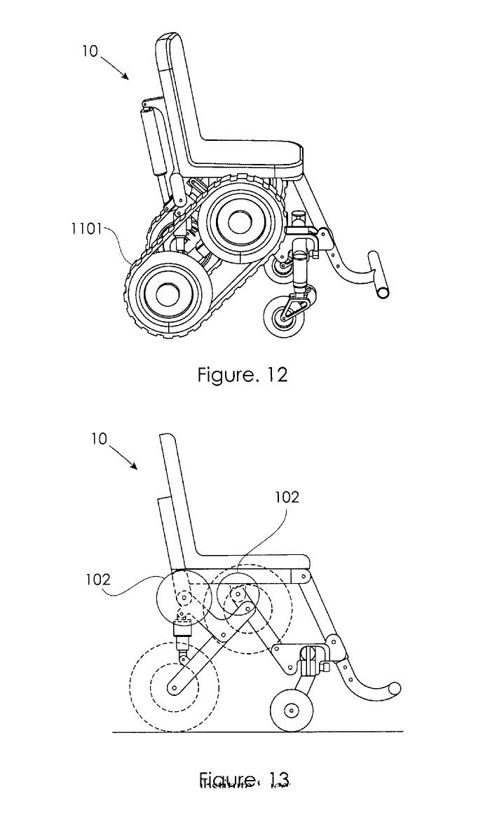

Referring now to the exemplary embodiment illustrated in FIG. 12, there is shown the vehicle 100 comprising a track 1101 located about the first wheel 22 and the second wheel 24. The track 1101 advantageously provides further all-terrain capabilities for the vehicle 10 allowing the vehicle 10 to traverse surfaces such as sand, snow and the like. In one embodiment, the track 1101 is removable so as to allow the vehicle 10 to be driven by the first and/or second wheels 22, 24 alone.

FIG. 13 illustrates an embodiment of the vehicle 10 employing two independent rotary actuators 181, 182 adapted for independently pivoting the first and second wheel assemblies 20, 40 to configure the vehicle 10 in the variety of configurations described above. The configuration of the first wheel assembly 20 and the second wheel assembly 40 can be controlled by the rotary actuators 181, 182 may be controlled by an embedded controller (not shown).

What is not shown in the drawings but would be included in embodiments of the vehicle 10 is a power source coupled to the linear actuator 80 such as an electric power source comprising a battery which may be rechargeable. Furthermore, the vehicle 10 may comprise a controller (not shown) for operation by the user in configuring the actuator and other functionality such as driving the wheels where the vehicle 10 comprises driven wheels.

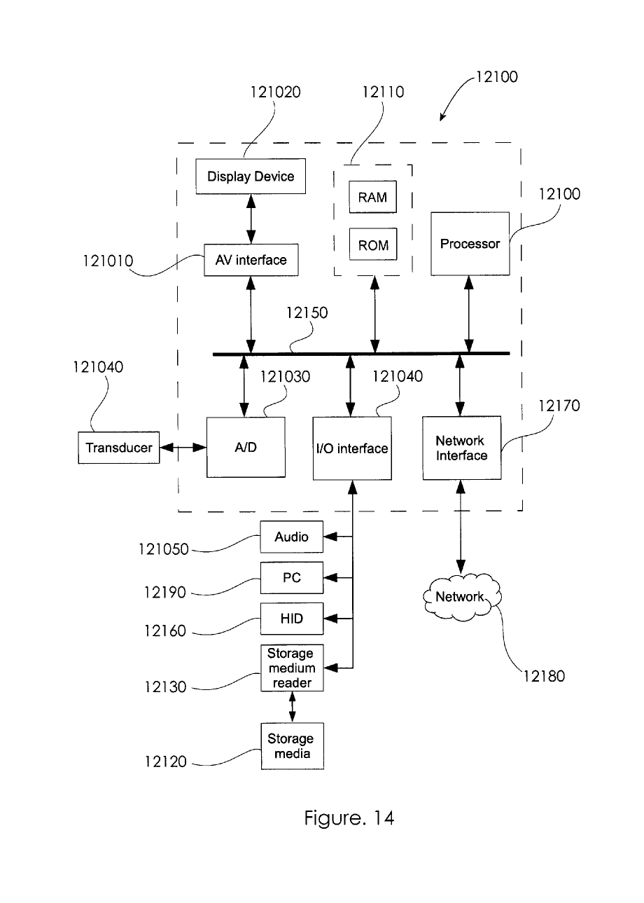

The controller may comprise a simple analog arrangement comprising toggle switches or the like providing binary up/down operation of the linear actuator. Alternatively, the controller may be implemented in the form of an embedded controller 12100 as substantially shown in FIG. 14 so as to provide enhanced user interface, safety and control functionality for the vehicle 10. The controller may be configured such that the user need not necessarily control the operation of the actuator 80, but rather where the controller controls the operation of the actuator 80 in accordance with a usage mode of the vehicle. For example, at low speeds, the controller may configure the vehicle 10 in the raised configuration as substantially shown in FIG. 1, whereas at increased speeds, the controller may configure the vehicle 10 in the lowered configuration as substantially shown in FIG. 2. Of course, the controller may configure the vehicle 10 in accordance with parameters other than speed of the vehicle 10.

Referring to FIG. 1, the vehicle 100 comprises a seat 101. In this embodiment, the vehicle 100 would advantageously be suitable for use as a wheelchair for disabled persons. In this manner, the vehicle 100 could be used in the raised configuration 100a of FIG. 1a while the user is at home for example and in the lowered configuration 100b of FIG. 1b when out and about. Furthermore, the ability of the vehicle 100 to be set at different heights may advantageously allow the user to lower the vehicle 100 for positioning beneath a table, raised for better interaction with others and the environment, lowered for better stability and the like.

FIG. 14 shows an embedded controller 12100 which may be employed in controlling the vehicle 10. The controller 12100 may be employed for the purposes of controlling not only the actuator 80 but also for controlling the drive of the first wheel 22 and the second wheel 24, including independent control of pairs of wheels comprising the first wheel 22 or the second wheel 24 so as to provide steering capability. The controller 12100 comprises memory 12110 which may comprise volatile memory (RAM) and/or non-volatile memory (ROM). Typically the memory 12110 comprises a combination of volatile and non-volatile memory, such that the non-volatile memory stores the controller 12100 firmware and the volatile memory stores one or more temporary results of the fetch-decode-execute cycle, as described below. The controller 12100 comprises a computer program code storage medium reader 12130 for reading data from a computer program code storage medium 12120. The storage medium 12120 may be optical media such as CD-ROM disks, magnetic media such as floppy disks and tape cassettes or flash media such as USB memory sticks. The I/O interface 12140 communicates with the storage medium reader 12130 and may take the form of a SCSI, USB or similar interface. The I/O interface 12140 may also communicate with one or more human input devices (HID) 12160 such as a keyboard or pointing devices. The I/O interface 12140 may also communicate with one or more personal computer (PC) devices 12190, using a suitable interface such as an RS-232 interface. The I/O interface may also communicate audio signals to one or more audio devices 121050, such as a speaker or a buzzer. The controller 12100 also comprises a network interface 12170 for communicating with one or more computer networks 12180. Network 12180 may be a wired network, such as a wired Ethernet network or a wireless network, such as a Bluetooth network or IEEE 802.11 network. The network 12180 may be a local area, such as a home or office computer network, or a wide area network, such as the Internet.

Typically computer program code is preloaded into the memory 12100. However, computer program code instructions may be loaded into the memory 12110 from the storage medium 12120 using the storage medium reader 12130 or from the network 12180. The controller 12100 comprises an arithmetic logic unit or processor 121000 for performing computer program code instructions. The processor 121000 is typically a low-power microprocessor suited to low power embedded controller applications. During the bootstrap phase, an operating system and one or more software applications are loaded the memory 12110. During the fetch-decode-execute cycle, the processor 121000 fetches computer program code instructions from memory 12110, decodes the instructions into machine code, executes the instructions and stores the results in the memory 12110.

The controller 12100 also comprises a video interface 121010 for conveying video signals to a display device 121020, such as a liquid crystal display (LCD), cathode-ray tube (CRT) or similar display device. The display device 121020 may be embedded in the controller 12100, or located remotely.

The controller 12100 further comprises an analog to digital (ND) converter 121030 for converting analog signals from transducer 121040 into a digital format. The transducer 121040 may be employed for differing purposes as the case may be, such as for allowing the controller 12100 to determine the rotational velocity of each of the first and second wheels 22, 24 of the vehicle 10, the angle of the vehicle 10 (such as by employing a solid state tri-axial gyroscope), momentum of the vehicle 10, battery charge state and any other parameters of the vehicle. The controller 12100 also comprises a communication bus 12150 for interconnecting the various devices described above.

According to differing embodiments, variations may be made to the vehicle 10 depending on the application. For example, a rotational coupling such as one comprising a motor, gearbox, cog or the like may be used instead of the linear actuator 80. Furthermore, the linear actuator 80 may be implemented by way of a hydraulic or pneumatic ram in place of an electric linear actuator. Yet further, the vehicle 10 may employ an internal combustion engine for propulsion as opposed to the electric motors described above.

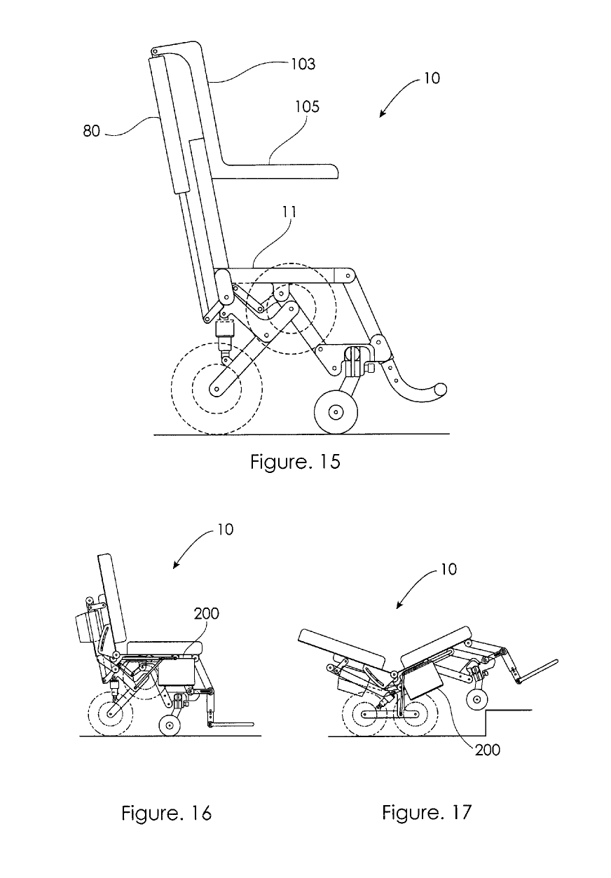

FIG. 15 illustrates a further embodiment of the vehicle 10 having the capability to independently raise and lower the height of the seat back 103 and the seat base 105 to facilitate a user sitting in the seat back 103 and seat base 105 elevating their position for the purposes of reaching items placed at different heights such as in cupboards and the like. Furthermore, in this manner, the user may position themselves at a height substantially level with normal standing eye height for improved social interaction. In this embodiment, the vehicle 10 is adapted to provide for the seat back 103 and seat base 105 to be elevated above the frame 11. In this embodiment, the linear actuator 80 includes a relatively long stroke compared with the previously described embodiments. In one embodiment, a single linear actuator 80 is employed to act both upon the first and second wheel assemblies 20, 40 and as well as to raise and lower the position of the seat back 103 and seat base 105.

FIGS. 16 and 17 illustrate an embodiment of the vehicle including a power storage device 200 that is adapted to move fore and aft relative to the frame 11 in response to pivoting of the first wheel assembly 20 about the first pivot axis 21. Thus, the weight of the power storage device 200 can be shifted fore and aft to assist in appropriate weight distribution of the vehicle 10 in the various configurations described herein.

The embodiments of the vehicle 10 illustrated in the Figures is in the form of a mobility aid for the disabled (such as a wheelchair), however, it should be understood that the vehicle 10 need not necessarily be limited to use for mobility assistance, and may, for example be used for other applications such as sporting activities, all-terrain capabilities, utility transport and the like.

Reference throughout this specification to “an embodiment” means that a particular feature, structure or characteristic described in connection with the embodiment is included in at least one embodiment of the present invention. Furthermore, the particular features, structures or characteristics may be combined in any suitable manner, as would be apparent to one of ordinary skill in the art from this disclosure, in one or more embodiments.

Similarly it should be appreciated that in the above description of example embodiments of the invention, various features of the invention are sometimes grouped together in a single embodiment, figure, or description thereof for the purpose of streamlining the disclosure and aiding in the understanding of one or more of the various inventive aspects. This method of disclosure, however, is not to be interpreted as reflecting an intention that the claimed invention requires more features than are expressly recited in each claim. Rather, as the following claims reflect, inventive aspects lie in less than all features of a single foregoing disclosed embodiment.

Furthermore, while some embodiments described herein include some but not other features included in other embodiments, combinations of features of different embodiments are meant to be within the scope of the invention, and form different embodiments, as would be understood by those in the art. For example, in the following claims, any of the claimed embodiments can be used in any combination.

In describing the preferred embodiment of the invention illustrated in the Figures, specific terminology is for the sake of convenience. However, the invention is not intended to be limited to the specific terms so selected, and it is to be understood that each specific term includes all technical equivalents which operate in a similar manner to accomplish a similar technical purpose.

In the claims which follow and in the preceding description of the invention, except where the context requires otherwise due to express language or necessary implication, the word “comprise” or variations such as “comprises” or “comprising” are used in an inclusive sense, i.e. to specify the presence of the stated features but not to preclude the presence or addition of further features in various embodiments of the invention.

1. A wheeled vehicle including:
a frame for supporting a seat for a user, the frame having a front and a rear with reference to a direction faced by a user sitting on the seat;
a first wheel assembly coupled towards the rear of the frame at a first pivot axis and including first and second wheels having parallel and spaced apart axes of rotation, wherein the first and second wheels of the first wheel assembly are adapted to pivot about the first pivot axis relative to the frame;
a second wheel assembly coupled towards the front of the frame and including a third wheel adapted to pivot about a second pivot axis relative to the frame;
wherein the first and second wheels of the first wheel assembly are pivotable in a first direction about the first pivot axis when the first and second wheels are supported on a surface to thereby tilts the frame and the seat supported on the frame rearwardly and raises the third wheel off the surface wherein the vehicle is entirely supported on the surface by the first and second wheels.

2. The wheeled vehicle of claim 1, wherein the vehicle is advanceable when the third wheel is raised off the surface to position the raised third wheel on an elevated surface wherein pivoting the first and second wheels of the first wheel assembly in an opposite second direction about the first pivot axis raises one of the first and second wheels off the lower surface whereby the vehicle is entirely supported by one of the first and second wheels on the lower surface and the third wheel on the elevated surface.

3. The wheeled vehicle of claim 2, wherein the seat tilts forward in response to the first and second wheels of the first wheel assembly pivoting in the second direction about the first pivot axis.

4. The wheeled vehicle of claim 2, further including a selectively engageable seat base lifting arm that has a proximal end pivotally coupled to the frame at the first pivot axis and when engaged is adapted to pivot with the first wheel assembly whereby a distal end of the seat base lifting arm is adapted to engage a base of the seat and tilt the seat forward relative to the frame.

5. (canceled)

6. The wheeled vehicle of claim 2, wherein the vehicle is advanceable when supported by one of the first and second wheels on the lower surface and the third wheel on the elevated surface to position the raised one of the first and second wheels on the elevated surface wherein the first and second wheels of the first wheel assembly are adapted to pivot about the first pivot axis in the first direction to thereby raise the other one of the first and second wheels off the lower surface wherein the vehicle is entirely supportable by at least one of the first and second wheels and by the third wheel on the elevated surface.

7. (canceled)

8. The wheeled vehicle of claim 6, wherein the vehicle is advanceable when the vehicle is entirely supported by the at least one of the first and second wheels and by the third wheel on the elevated surface to position the other one of the first and second wheels on the elevated surface.

9. The wheeled vehicle of claim 1, wherein the first wheel assembly is pivotable about the first pivot axis between three positions relative to the frame including first and second oppositely tilted positions and an intermediate position and the second wheel assembly is pivotable about the second pivot axis relative to the frame between two positions relative to the frame including a relatively steep position and a relatively shallow position.

10. The wheeled vehicle of claim 9, wherein in the first tilted position of the first wheel assembly the second wheel assembly is in the steep position and the vehicle is substantially entirely supportable on a level surface by the one of the first and second wheels and the third wheel, wherein the other one of the first and second wheels is raised off the surface.

11. The wheeled vehicle of claim 9, wherein in the intermediate and second tilted positions of the first wheel assembly the second wheel assembly is in the shallow position.

12. The wheeled vehicle of claim 1, further including a mechanism for transmitting pivoting motion of the first wheel assembly about the first pivot axis or the second wheel assembly about the second pivot axis into the pivoting motion of the other one of the first and second wheel assemblies.

13. (canceled)

14. The wheeled vehicle of claim 1, wherein the first wheel assembly includes a first sub-frame pivotally coupled to the frame at the first pivot axis, wherein the first sub-frame includes a first arm pivotally coupled to a second arm, the second arm being pivotally coupled to the frame at the first pivot axis, wherein the first wheel is rotatably coupled to the first arm and the second wheel is rotatably coupled to the second arm whereby the first wheel is adapted to pivot about the pivotal coupling of the first arm to the second arm.

15. The wheeled vehicle of claim 1, wherein the second wheel assembly includes a second sub-frame including an arm having a proximal end pivotally coupled to the frame at the second pivot axis and a distal end linked to the third wheel.

16. (canceled)

17. The wheeled vehicle of claim 15, wherein the second sub-frame includes a transverse member pivotally coupled to the linkage member, wherein the third wheel includes at least one wheel rotatably coupled to a distal end of the transverse member outboard of the linkage member, wherein the transverse member is adapted to pivot in a frontal plane relative to the linkage member.

18. (canceled)

19. (canceled)

20. The wheeled vehicle of claim 17, wherein the third wheel includes a pair of swivel casters depending from distal ends of the transverse member outboard of the linkage member.

21. The wheeled vehicle of claim 1, wherein the frame includes a seat support including a seat base support for supporting a base of the seat and a seat back support for supporting a back supporting portion of the seat, the seat back support being pivotal relative to the seat base support between a relatively upright position and a relatively reclined position, wherein the seat back support is adapted to tilt to the relatively reclined position away from the seat base support when the first wheel assembly is pivoted in the first direction about the first pivot axis, and wherein the seat back support is maintained in the upright position through a first part of a pivotal range of motion of the first wheel assembly about the first pivot axis and is movable relative to the reclined position through a second part of the pivotal range of motion of the first wheel assembly about the first pivot axis.

22. (canceled)

23. (canceled)

24. A method of operation of a wheeled vehicle on a level surface, the vehicle including a frame, a first wheel assembly including first and second wheels having parallel and spaced apart axes of rotation, wherein the first and second wheels are adapted to pivot about a first pivot axis relative to the frame, a second wheel assembly including a third wheel adapted to pivot about a second pivot axis relative to the frame, the method including:
configuring the vehicle in a first configuration in which the first wheel assembly is in a first tilted position and in which the second wheel assembly is in a steep position relative to the frame in which one of the first and second wheels is raised above a level surface and the other one of the first and second wheels and the third wheel are on the surface;
pivoting the first wheel assembly about the first pivot axis to an intermediate position relative to the frame and pivoting the second wheel assembly about the second pivot axis to a shallow position relative to the frame to configure the vehicle with the first, second and third wheels on the surface;
pivoting the first wheel assembly about the first pivot axis to a second tilted position relative to the frame to configure the vehicle in a configuration in which the first and second wheels are on the surface and the third wheel is raised above the surface.

25. A method for ascending a step using a vehicle including a frame, a first wheel assembly including first and second wheels having parallel and spaced apart axes of rotation, wherein the first and second wheels are adapted to pivot about a first pivot axis relative to the frame, a second wheel assembly including a third wheel adapted to pivot about a second pivot axis relative to the frame, the method including:
configuring the vehicle in a first configuration in which the first wheel assembly is in a first tilted position and in which the second wheel assembly is in a steep position relative to the frame in which one of the first and second wheels is raised above a level surface and the other one of the first and second wheels and the third wheel are on the surface;
pivoting the first wheel assembly about the first pivot axis to an intermediate position relative to the frame and pivoting the second wheel assembly about the second pivot axis to a shallow position relative to the frame to configure the vehicle with the first, second and third wheels on the surface;
pivoting the first wheel assembly about the first pivot axis to a second tilted position relative to the frame to configure the vehicle in a configuration in which the first and second wheels are on the surface and the third wheel is raised above the surface;
advancing the vehicle to place the third wheel on an upper surface of a step raised above the level surface;
pivoting the first wheel assembly to a position between the first titled position and the intermediate position and pivoting the second wheel assembly towards the steep position to lift one of the first and second wheels above the level surface and further advancing the vehicle to place the lifted one of the first and second wheels on the upper surface;
pivoting the first wheel assembly towards the intermediate position to lift the other one of the first and second wheels above the level surface and further advancing the vehicle to place the first, second and third wheels on the upper surface.

26. A method for descending a step using a vehicle including a frame, a first wheel assembly including first and second wheels having parallel and spaced apart axes of rotation, wherein the first and second wheels are adapted to pivot about a first pivot axis relative to the frame, a second wheel assembly including a third wheel adapted to pivot about a second pivot axis relative to the frame, the method including:
configuring the vehicle in a first configuration in which the first wheel assembly is in a first tilted position and in which the second wheel assembly is in a steep position relative to the frame in which one of the first and second wheels is raised above a level surface and the other one of the first and second wheels and the third wheel are on the surface;
pivoting the first wheel assembly about the first pivot axis to an intermediate position relative to the frame and pivoting the second wheel assembly about the second pivot axis to a shallow position relative to the frame to configure the vehicle with the first, second and third wheels on the surface;
pivoting the first wheel assembly about the first pivot axis to a second tilted position relative to the frame to configure the vehicle in a configuration in which the first and second wheels are on the surface and the third wheel is raised above the surface;
advancing the vehicle to place the third wheel over an edge of a step and above the level of a lower surface and further advancing the vehicle to place one of the first and second wheels over the edge of the step causing the vehicle to tilt over the edge of the step until the one of the first and second wheel and the third wheel are on the lower surface;
further advancing the vehicle and pivoting the first wheel assembly to the intermediate position to configure the vehicle with the first, second and third wheels on the lower surface.

27. A wheel assembly for a vehicle, the wheel assembly including at least two swivel castor wheels rotatably coupled to opposite ends of a transverse member, wherein at a point intermediate the opposite ends the transverse member is pivotally coupled to a linkage member that is adapted to be coupled to a vehicle, wherein the transverse member is adapted to pivot relative to the linkage member to provide for relative vertical movement of the swivel castor wheels and to maintain the swivel axes of the swivel castor wheels in a vertical orientation relative to the horizontal.

28. The wheel assembly of claim 27, wherein the transverse member includes first and second vertically spaced apart transverse members, the first transverse member being pivotally coupled at a midpoint thereof to the linkage member, the second transverse member being pivotally coupled at a midpoint to the linkage member, wherein the pivotal coupling between the second transverse member and the linkage member is movable in an arcuate path, whereby distal outboard ends of the first and second linkage members are maintained in substantially fixed vertically aligned positions relative to each other through a pivotal range of motion of the first and second transverse members relative to the linkage member.

29-30. (canceled)
